(19) United States
(12) Patent Application Publication
(10) Pub. No.: US 2025/0119930 A1
(43) Pub. Date: Apr. 10, 2025

(54) TRANSMISSION METHOD, DEVICE, AND READABLE STORAGE MEDIUM

(71) Applicant: VIVO MOBILE COMMUNICATION CO., LTD., Dongguan (CN)

(72) Inventors: Lei JIANG, Dongguan (CN); Huan WANG, Dongguan (CN); Zichao JI, Dongguan (CN)

(73) Assignee: VIVO MOBILE COMMUNICATION CO., LTD., Dongguan (CN)

(21) Appl. No.: 18/988,767

(22) Filed: Dec. 19, 2024

Related U.S. Application Data
(63) Continuation of application No. PCT/CN2023/100175, filed on Jun. 14, 2023.

(30) Foreign Application Priority Data
Jun. 21, 2022 (CN) 202210709385.3

(51) Int. Cl. H04W 72/40; H04L 5/00; H04W 52/52; H04W 72/0446; H04W 74/0816

(52) U.S. Cl. CPC H04W 72/40; H04L 5/0051; H04W 52/52; H04W 72/0446; H04W 74/0816

(57) ABSTRACT

This application provides a transmission method, a device, and a readable storage medium. The method includes: performing, by a terminal, sidelink (SL) transmission in a mini-slot. A length of the mini-slot is less than a length of one slot, and one slot includes one or more starting positions of the mini-slot.

### CROSS-REFERENCE TO RELATED APPLICATIONS

This application is a continuation of International Application No. PCT/CN 2023/100175, filed on Jun. 14, 2023, which claims priority to Chinese Patent Application No. 202210709385.3 filed on Jun. 21, 2022. The entire contents of each of the above-referenced applications are expressly incorporated herein by reference.

### TECHNICAL FIELD

This application relates to the field of communication technologies, and specifically, to a transmission method, a device, and a readable storage medium.

### BACKGROUND

According to an existing sidelink (SL) channel structure, each SL transmission (for example, a physical sidelink control channel (PSCCH) or/a physical sidelink shared channel (PSSCH)) starts from a fixed (periodic) position (for example, a starting position of the slot) by using a fixed length (for example, one slot) as a minimum transmission unit. However, in an unlicensed band, in a listen before talk (LBT) channel access mechanism, time at which a channel is detected to be idle is uncertain. If the time at which the channel is idle is not a starting position of the slot, the SL cannot perform transmission immediately, and needs to defer to a starting position of a next slot for transmission. As a result, resource utilization is reduced, and the channel may be occupied by another device in the unlicensed band in the deferring process. Therefore, the existing slot-based SL transmission has poor performance in the unlicensed band.

### SUMMARY

Embodiments of this application provide a transmission method, a device, and a readable storage medium.

According to a first aspect, a transmission method is provided. The method includes:

performing, by a terminal, sidelink SL transmission in a mini-slot, where

a length of the mini-slot is less than a length of one slot, and one slot includes one or more starting positions of the mini-slot.

According to a second aspect, a transmission apparatus is provided, including:

a transmission module, configured to perform SL transmission in a mini-slot, where

a length of the mini-slot is less than a length of one slot, and one slot includes one or more starting positions of the mini-slot.

According to a third aspect, a terminal is provided. The terminal includes a processor and a memory. The memory stores a program or instructions executable on the processor. When the program or the instructions are executed by the processor, the steps of the method according to the first aspect are implemented.

According to a fourth aspect, a terminal is provided, including a processor and a communication interface. The processor is configured to perform sidelink SL transmission in a mini-slot, where

a length of the mini-slot is less than a length of one slot, and one slot includes one or more starting positions of the mini-slot.

According to a fifth aspect, a readable storage medium is provided. The readable storage medium stores a program or instructions. When the program or the instructions are executed by a processor, the steps of the method according to the first aspect are implemented.

According to a sixth aspect, a chip is provided. The chip includes a processor and a communication interface, the communication interface is coupled to the processor, and the processor is configured to run a program or instructions to implement the method according to the first aspect.

According to a seventh aspect, a computer program/program product is provided. The computer program/program product is stored in a storage medium, and the computer program/program product is executed by at least one processor to implement the steps of the method according to the first aspect.

According to an eighth aspect, an electronic device is provided. The electronic device is configured to perform the steps of the method according to the first aspect.

In the embodiments of this application, mini-slot-based SL transmission is used, so that an SL UE can increase transmission opportunities in the unlicensed band, improving resource utilization.

### BRIEF DESCRIPTION OF THE DRAWINGS

FIG. 1 is a block diagram of a wireless communication system according to an embodiment of this application;

FIG. 2 shows an existing SL channel structure;

FIG. 3 is a schematic flowchart of a transmission method according to an embodiment of this application;

FIG. 4a is one of schematic diagrams of an application example according to an embodiment of this application;

FIG. 4b is one of schematic diagrams of an application example according to an embodiment of this application;

FIG. 4c is one of schematic diagrams of an application example according to an embodiment of this application;

FIG. 5 is a schematic diagram of a structure of a transmission apparatus according to an embodiment of this application;

FIG. 6 is a schematic diagram of a structure of a communication device according to an embodiment of this application; and

FIG. 7 is a schematic diagram of a structure of a terminal according to an embodiment of this application.

### DETAILED DESCRIPTION

The following clearly describes the technical solutions in the embodiments of this application with reference to the accompanying drawings in the embodiments of this application. Apparently, the described embodiments are some of the embodiments of this application rather than all of the embodiments. All other embodiments obtained by a person of ordinary skill in the art based on the embodiments of this application fall within the protection scope of this application.

The specification and claims of this application, and terms “first” and “second” are used to distinguish similar objects, but are unnecessarily used to describe a specific sequence or order. It should be understood that the terms in such a way are interchangeable in proper circumstances, so that the embodiments of this application can be implemented in other orders than the order illustrated or described herein. Objects distinguished by “first”, “second”, and the like are usually one type, and a number of objects is not limited. For example, a first object may be one or more than one. In addition, in the specification and the claims, “and/or” represents at least one of connected objects, and the character “/” generally represents an “or” relationship between associated objects.

It should be noted that, the technologies described in the embodiments of this application are not limited to a long term evolution (LTE)/an LTE-advanced (LTE-A) system, and may further be applied to other wireless communication systems, such as, code division multiple access (CDMA), time division multiple access (TDMA), frequency division multiple access (FDMA), orthogonal frequency division multiple access (OFDMA), single-carrier frequency division multiple access (SC-FDMA), and other systems. The terms “system” and “network” in the embodiments of this application are often used interchangeably, and the described technology can be used not only for the above systems and radio technologies, but also for other systems and radio technologies. The following description describes a new radio (New Radio, NR) system for example objectives, and NR terms are used in most of the description below, although these technologies are also applicable to applications other than NR system applications, such as a 6th generation (6G) communication system.

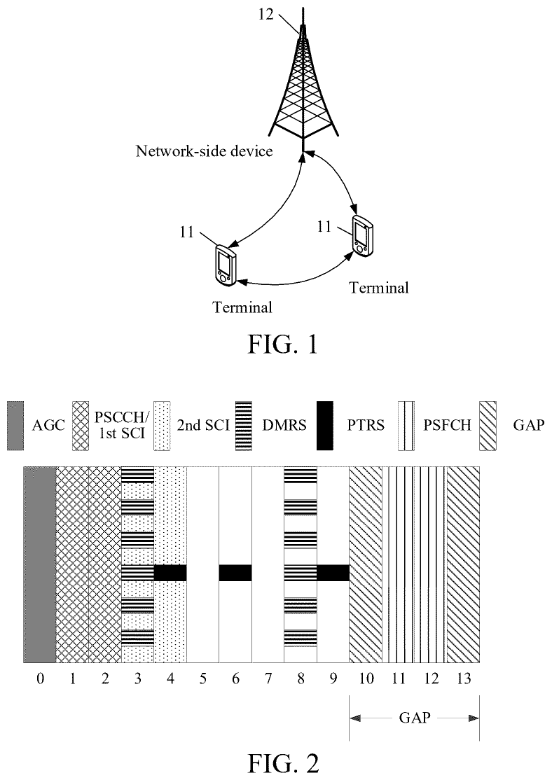

FIG. 1 is a block diagram of a wireless communication system to which an embodiment of this application is applicable. The wireless communication system includes a terminal 11 and a network-side device 12. The terminal 11 may be a mobile phone, a tablet personal computer, a laptop computer or referred to as a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, a vehicle user equipment (VUE), a pedestrian user equipment (PUE), a smart home (a home device having a wireless communication function, for example, a refrigerator, a television, a washing machine, or furniture), a game console, a personal computer (PC), a teller machine, a self-service machine, or another terminal-side device. The wearable device includes a smart watch, a smart band, a smart headset, smart glasses, smart jewelry (a smart bangle, a smart bracelet, a smart ring, a smart necklace, a smart anklet, and the like), a smart wristband, smart clothing, and the like. It should be noted that a specific type of the terminal 11 is not limited in the embodiments of this application. The network-side device 12 may include an access network device or a core network device. The access network device may also be referred to as a radio access network device, a radio access network (RAN), a radio access network function, or a radio access network unit. The access network device may include a base station, a wireless local area network (WLAN) access point, a wireless fidelity (WiFi) node, or the like. The base station may be referred to as a node B, an evolved node B (eNB), an access point, a base transceiver station (BTS), a radio base station, a radio transceiver, a basic service set (BSS), an extended service set (ESS), a home node B, a home evolved node B, a transmitting receiving point (TRP), or another proper term in the art. As long as the same technical effect is achieved, the base station is not limited to a specific technical term. It should be noted that only the base station in an NR system is used as an example for description in the embodiments of this application, and a specific type of the base station is not limited.

To better understand the technical solutions of this application, the following content is first described.

### Unlicensed Band

In a future communication system, an unlicensed band may be used as a supplement to a licensed band to help operators upscale services. To be consistent with NR deployment and maximize NR-based unlicensed access as much as possible, the unlicensed band may operate in 5 GHz, 37 GHz, and 60 GHz bands. A large bandwidth (80 or 100 MHz) of the unlicensed band can reduce implementation complexity of a base station and a terminal (or, User Equipment (UE)). Since the unlicensed band is shared by a plurality of technologies (radio access technologies (RATs)), for example, WiFi, radar, and LTE-licensed-assisted access (LAA), in some countries or regions, use of the unlicensed band needs to comply with regulations, for example, regulations such as listen before talk (LBT) and maximum channel occupancy time (MCOT), to ensure that all devices can fairly use the resource. When a transmission node needs to perform LBT before transmitting information, the transmission node performs energy detection (ED) on surrounding nodes. When detected energy is less than a threshold, it is considered that a channel is idle, and the transmission node can perform transmission. Conversely, it is considered that the channel is busy, and the transmission node cannot perform transmission. The transmission node may be a base station, a UE, a WiFi AP, or the like. After the transmission node starts transmission, channel occupancy time (COT) cannot exceed the MCOT. In addition, according to an occupied channel bandwidth (OCB) regulation, in the unlicensed band, the transmission node needs to occupy at least 70% (60 GHz) or 80% (5 GHz) of the bandwidth of the entire band during each transmission.

Types of the LBT commonly used in New Radio Unlicensed (NRU) may be classified into Type1, Type2A, Type2B, and Type2C. Type1 LBT is a back-off based channel listening mechanism. When listening that the channel is busy, the transmission node performs back-off and continues listening until listening that the channel is idle. Type2C means that the transmission node does not perform LBT, that is, no LBT or immediate transmission. Type2A and Type2B LBT are one-shot LBT, that is, the node performs LBT once before transmission, performs transmission if a channel is idle, and does not perform transmission if the channel is busy. A difference is that Type2A performs LBT in 25 us, which is applicable to a case that a gap between two transmissions is greater than or equal to 25 us when the COT is shared, while Type2B performs LBT in 16 us, which is applicable to a case that a gap between two transmissions is equal to 16 us when the COT is shared. In addition, Type2 LBT is applicable to LAA/eLAA/FeLAA. When the COT is shared, a gap between two transmissions is greater than or equal to 25 us, and the eNB and the UE may use Type2 LBT. In addition, in a frequency range 2-2, types of LBT include Type1, Type2, and Type3. Type1 is a back-off-based channel listening mechanism, Type2 is one-shot LBT and LBT of 5 us is performed in 8 us, and Type3 does not perform LBT.

A DL/UL transmission burst is a group of transmissions transmitted by the base station or the UE with a gap not greater than 16 us. For transmission in a DL/UL transmission burst, the base station or the UE may perform direct transmission without LBT after the gap. When the gap between transmissions is greater than 16 us, the gap may be considered as a separate DL/UL transmission burst.

### Introduction of SL

Sidelink (or translated as side link, or the like) transmission is transmission of data between terminals (User Equipments (UEs)) directly on a physical layer. A LTE sidelink performs communication based on broadcasting, and may be used to support basic safety-type communication of vehicle to everything (vehicle to everything (V2X)), but is not applicable to other higher-level V2X services. A 5G New Radio (NR) system supports a more advanced sidelink transmission design, for example, unicast, multicast, or groupcast, thereby supporting a more comprehensive service type.

### SL Physical Channel

As shown in FIG. 2, an automatic gain control (AGC) symbol is required before each SL transmission, and a gap symbol is required after each transmission. The AGC symbol is generally repeated transmission of a next symbol, for example, a PSCCH/PSSCH or a physical sidelink feedback channel (PSFCH). In the figure, there are two symbols of PSFCH, and a 1st symbol is used for AGC. The SL UE can start transmission of the PSCCH/PSSCH or PSFCH only at a fixed position in the slot. SCI is sidelink control information (SCI), and PTRS is a phase-tracking reference signal (PTRS).

The transmission method provided in the embodiments of this application is described in detail below through some embodiments and application scenarios thereof with reference to the accompanying drawings.

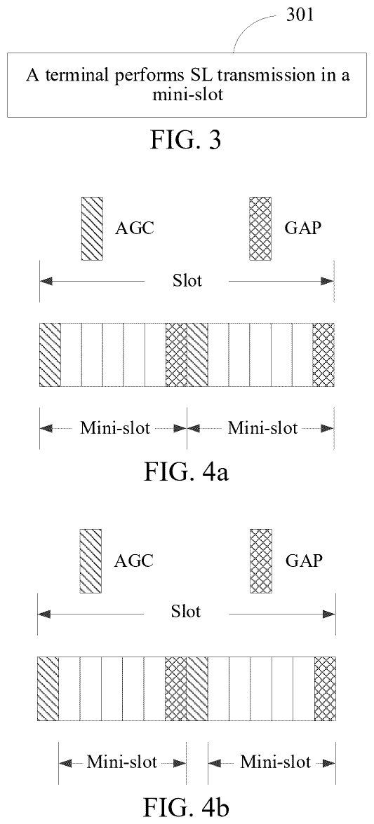

Referring to FIG. 3, an embodiment of this application provides a transmission method, including the following steps.

Step 301: A terminal performs SL transmission in a mini-slot.

A length of the mini-slot is less than a length of one slot, and one slot includes one or more starting positions of the mini-slot.

For example, the terminal may be a terminal used as a transmitting end in SL communication.

In the embodiments of this application, mini-slot-based SL transmission is used, so that an SL UE can increase transmission opportunities in the unlicensed band, improving resource utilization.

In some embodiments, the terminal performs SL transmission in a mini-slot manner. The mini-slot is a transmission unit having a length less than or equal to 13 symbols (that is, the length of the mini-slot needs to be less than the length of one slot). For example, the length of the mini-slot may be 5 symbols, 7 symbols, or the like. The SL transmission may be the PSCCH, the PSSCH, or a physical sidelink feedback channel (PSFCH). There may be one or more starting positions of the mini-slot in one slot. The starting position and/or the length of the mini-slot may be predefined or (pre-) configured in a protocol.

In a possible implementation, the mini-slot meets one or more of the following:

(1) One AGC symbol exists at a starting position of the mini-slot. One AGC symbol is configured for each mini-slot, so that the UE can accurately adjust a power reception range through measurement of the AGC symbol during reception.

(2) One GAP symbol exists at an end position of the mini-slot. One GAP symbol is configured for each mini-slot to ensure that the UE has sufficient transmission switching time.

(3) One AGC symbol exists at a starting position of the SL transmission of a 1st mini-slot in one slot. In some embodiments, to save AGC symbols, for the case in (1) in which one AGC symbol is configured for each mini-slot, if the mini-slots are for continuous transmission, after the power reception range is accurately adjusted based on the first measurement of the AGC symbol, no AGC symbol may be set in the following mini-slots. In some embodiments, each AGC symbol duplicates a symbol of a next or previous SL transmission.

In some embodiments, the AGC symbols in the slot are a protocol-specific or configured sequence (for example, an M sequence or a Gold sequence, a Zadoff-Chu sequence, or a low peak-to-average power ratio (low-PAPR) sequence) or a sequence initialized by using a specific value.

In some embodiments, a receiving terminal (Rx UE) of slot-based SL transmission performs rate matching according to all AGC symbols in the slot.

(4) One GAP symbol exists at an end position of SL transmission of a last mini-slot in one slot. In some embodiments, to save AGC symbols, for the case in (2) in which one GAP symbol is configured for each mini-slot, if the mini-slots are for continuous transmission, there is no transmission switching between the mini-slots, and no GAP may be set in mini-slots before the last mini-slot.

(5) M AGC symbols are configured in one slot, and the SL transmission of each mini-slot starts after each AGC symbol, where M is a number of the mini-slots in one slot. In some embodiments, the M AGC symbols herein may be AGC symbols for slot-based transmission, that is, mini-slot transmission reuses AGC symbols for slot-based transmission.

(6) One first symbol is configured between two adjacent mini-slots in one slot, where the first symbol is the GAP symbol or the AGC symbol.

In a possible implementation, the method further includes one or more of the following:

(1) In a case that an AGC symbol of the mini-slot conflicts with a demodulation reference signal (DMRS) symbol, the terminal transmits the AGC symbol after the DMRS symbol.

(2) In a case that an AGC symbol of the mini-slot conflicts with a DMRS symbol, the terminal shifts the DMRS symbol backward by one symbol.

(3) In a case that an AGC symbol of the mini-slot conflicts with a DMRS symbol, the terminal selects a DMRS pattern that does not conflict with the AGC symbol, where different DMRS patterns are different resource mapping for DMRS. This is equivalent to selecting a DMRS resource that does not conflict with the AGC, and correspondingly the receiving end UE does not expect the DMRS to conflict with the AGC.

In a possible implementation, the starting position of the mini-slot meets one or more of the following:

(1) The starting position of the mini-slot is located after X symbols from a previous PSCCH transmission occasion, where X is time for demodulating a PSCCH.

(2) Y GAP symbols exist before the starting position of the mini-slot, and the terminal performs deferred listen before talk deferred LBT in the GAP symbols.

In a possible implementation, in a case that a transmission resource of a PSFCH overlaps with a transmission resource of the mini-slot, the method further includes one or more of the following:

(1) The terminal transmits the PSFCH. That is, a transmission priority of the PSFCH is higher than that of mini-slot transmission, and the PSFCH is not transmitted on a mini-slot resource.

(2) The terminal ends the SL transmission in the mini-slot in advance, or the terminal postpones the start of the SL transmission in the mini-slot.

In some embodiments, that the terminal ends the SL transmission in the mini-slot in advance includes: the terminal determines a starting position of the PSFCH as an end position of the mini-slot; and that the terminal postpones the start of the SL transmission in the mini-slot includes: the terminal determines an end position of the PSFCH as the starting position of the mini-slot.

(3) The terminal transmits the PSFCH in a part of symbols in the mini-slot, and transmits data in another part of symbols (that is, remaining mini-slot symbols) in the mini-slot.

The following describes the technical solutions of this application with reference to specific application examples.

### Example 1

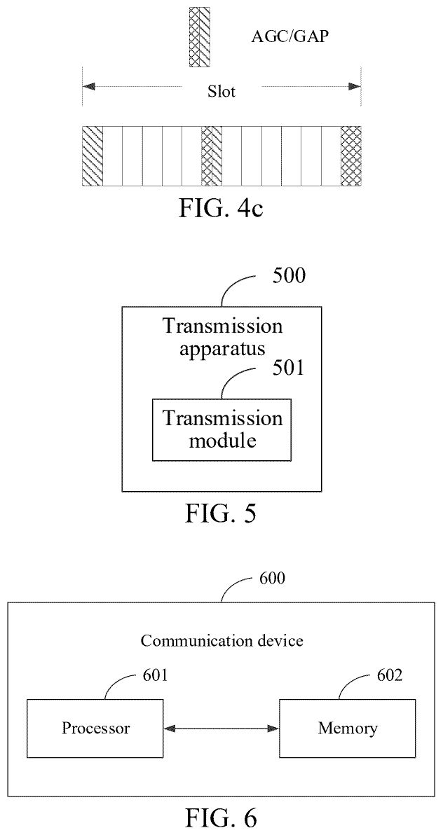

Referring to FIG. 4a and FIG. 4b, an example in which the length of the mini-slot is equal to 7 symbols is used, and there are two mini-slots in one slot. A 1st symbol of each mini-slot is configured as the AGC symbol, and the last symbol of each mini-slot is configured as the GAP symbol. The SL can only start transmission from the starting position of the mini-slot. Actually transmitted AGC and reserved GAP symbols are in the following manners:

1. One AGC symbol exists at a starting position of the mini-slot, and one GAP symbol exists at the end position of the mini-slot, that is, regardless of a mini-slot in which the SL performs transmission, the AGC and GAP symbols both exist.

2. One AGC symbol exists at a starting position of the SL transmission of a 1st mini-slot in one slot. That is, when the SL transmission starts from a 1st available mini-slot in the slot, if a subsequent mini-slot exists, the AGC symbol of the subsequent mini-slot skips transmission or is used to transmit data.

3. One GAP symbol exists at the end position of SL transmission of a last mini-slot in one slot. That is, when the SL transmission starts from the 1st available mini-slot in the slot, only the GAP symbol of the last mini-slot is reserved. Other GAP symbols may be filled with data.

When a transmission position of the AGC is fixed in the slot, the mini-slot may be a transmission unit starting from the AGC symbol, similar to that shown in FIG. 4a. In addition, for example, the mini-slot may not include the transmission unit of the AGC. In FIG. 4b, two mini-slots exist in one slot, but the length of each mini-slot is only 6 symbols. A GAP symbol in which an AGC symbol fixedly appears in the 1st mini-slot of a symbol 0 and a symbol 7 may be used as a GAP, or may be used to transmit data when data is transmitted in the 1st mini-slot.

### Example 2

Referring to FIG. 4c, in one slot, one AGC symbol exists at a starting position of SL transmission of the 1st mini-slot, that is, one AGC symbol is configured for the 1st mini-slot; one GAP symbol exists at the end position of SL transmission of a last mini-slot, that is, one GAP symbol is configured for the last mini-slot; and one first symbol is configured between two adjacent mini-slots in one slot. The first symbol is the GAP symbol or the AGC symbol, that is, one GAP/AGC symbol is configured between every two mini-slots. As shown in FIG. 4c, the effect of the GAP/AGC symbol has the following several different implementations.

1. When data is transmitted in a previous mini-slot, and no data is transmitted in a next mini-slot, the symbol may be used as the GAP symbol.

2. When data is transmitted in both a previous mini-slot and a next mini-slot, the symbol may be used as the AGC symbol or filled with data.

3. When no data is transmitted in a previous mini-slot and data is transmitted in a next mini-slot, the symbol may be used as the AGC symbol

It should be noted that no data being transmitted may be because the unlicensed band channel is busy (LBT fails), or the SL UE has no data to transmit.

The transmission method provided in the embodiments of this application may be performed by a transmission apparatus. In the embodiments of this application, an example in which the transmission apparatus performs the transmission method is used to describe the transmission apparatus provided in the embodiments of this application.

Referring to FIG. 5, an embodiment of this application provides a transmission apparatus 500, including:

a transmission module 501, configured to perform SL transmission in a mini-slot, where

a length of the mini-slot is less than a length of one slot, and one slot includes one or more starting positions of the mini-slot.

In a possible implementation, the mini-slot meets one or more of the following:

one AGC symbol exists at a starting position of the mini-slot;

one GAP symbol exists at an end position of the mini-slot;

one AGC symbol exists at a starting position of the SL transmission of a 1st mini-slot in one slot;

one GAP symbol exists at an end position of SL transmission of a last mini-slot in one slot;

M AGC symbols are configured in one slot, and the SL transmission of each mini-slot starts after each AGC symbol, where M is a number of the mini-slots in one slot; and

one first symbol is configured between two adjacent mini-slots in one slot, where the first symbol is the GAP symbol or the AGC symbol.

In a possible implementation, the apparatus further includes a first processing module, configured to perform one or more of the following:

in a case that an AGC symbol of the mini-slot conflicts with a DMRS symbol, transmitting the AGC symbol after the DMRS symbol;

in a case that an AGC symbol of the mini-slot conflicts with a DMRS symbol, shifting the DMRS symbol backward by one symbol; and

in a case that an AGC symbol of the mini-slot conflicts with a DMRS symbol, selecting a DMRS pattern that does not conflict with the AGC symbol.

In a possible implementation, the starting position of the mini-slot meets one or more of the following:

the starting position of the mini-slot is located after X symbols from a previous physical sidelink control channel PSCCH transmission occasion, where X is time for demodulating a PSCCH; and

Y GAP symbols exist before the starting position of the mini-slot, and deferred listen before talk deferred LBT is performed in the GAP symbols.

In a possible implementation, in a case that a transmission resource of a PSFCH overlaps with a transmission resource of the mini-slot, the apparatus further includes a second processing module, configured to perform one or more of the following:

transmitting the PSFCH;

ending the SL transmission in the mini-slot in advance, or postponing the start of the SL transmission in the mini-slot; and

transmitting the PSFCH in a part of symbols in the mini-slot, and transmitting data in another part of symbols in the mini-slot.

In a possible implementation, for example, the second processing module is configured to:

determine a starting position of the PSFCH as an end position of the mini-slot; and

determine an end position of the PSFCH as the starting position of the mini-slot.

The transmission apparatus in the embodiments of this application may be an electronic device, for example, an electronic device having an operating system, or may be a component, for example, an integrated circuit or a chip in an electronic device. The electronic device may be a terminal or may be another device other than a terminal. For example, the terminal may include, but not limited to, the types of the terminal 11 listed above, and another device may be a server, a network attached storage (NAS), and the like. This is not specifically limited in the embodiments of this application.

The transmission apparatus provided in this embodiment of this application can implement the processes implemented in the method embodiments shown in FIG. 3 to FIG. 4c, and achieve the same technical effects. To avoid repetition, details are not described herein again.

In some embodiments, as shown in FIG. 6, an embodiment of this application further provides a communication device 600, including a processor 601 and a memory 602. The memory 602 stores a program or instructions executable on the processor 601. For example, when the communication device 600 is a terminal, when the program or the instructions are executed by the processor 601, the steps of the foregoing transmission method embodiments are implemented, and the same technical effects can be achieved. When the communication device 600 is a network-side device, when the program or the instructions are executed by the processor 601, the steps of the foregoing transmission method embodiments are implemented, and the same technical effects can be achieved. To avoid repetition, details are not described herein again.

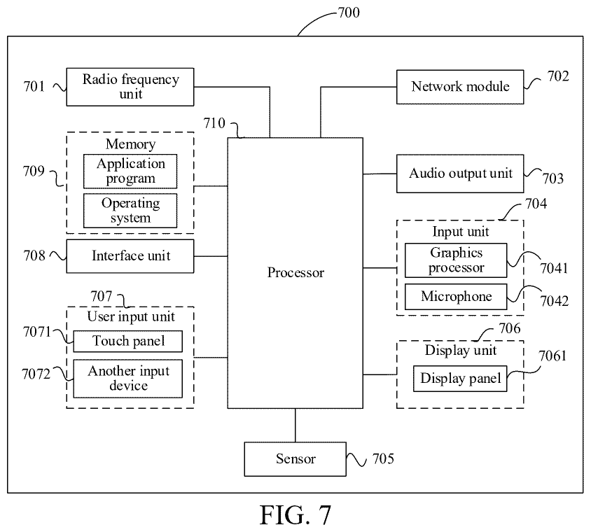

An embodiment of this application further provides a terminal, including a processor and a communication interface. The processor is configured to perform sidelink SL transmission in a mini-slot, where a length of the mini-slot is less than a length of one slot, and one slot includes one or more starting positions of the mini-slot. The terminal embodiment corresponds to the foregoing terminal-side method embodiment, and the implementation processes and implementations of the foregoing method embodiments are applicable to the terminal embodiment, and the same technical effects can be achieved. In some embodiments, FIG. 7 is a schematic diagram of a hardware structure of a terminal according to an embodiment of this application.

The terminal 700 includes, but is not limited to, at least some of components such as a radio frequency unit 701, a network module 702, an audio output unit 703, an input unit 704, a sensor 705, a display unit 706, a user input unit 707, an interface unit 708, a memory 709, and a processor 710.

A person skilled in the art may understand that the terminal 700 may further include a power supply (such as a battery) for supplying power to the components. The power supply may be logically connected to the processor 710 by using a power supply management system, thereby implementing functions such as charging, discharging, and power consumption management by using the power supply management system. The terminal structure shown in FIG. 7 does not constitute a limitation on the terminal, and the terminal may include more or fewer components than those shown in the figure, or combine some components, or have different component arrangements. Details are not described herein again.

It should be understood that, in this embodiment of this application, the input unit 704 may include a graphics processing unit (GPU) 7041 and a microphone 7042. The graphics processing unit 7041 processes image data of a static picture or a video obtained by an image capture apparatus (for example, a camera) in a video capture mode or an image capture mode. The display unit 706 may include a display panel 7061, and the display panel 7061 may be configured in a form such as a liquid crystal display or an organic light-emitting diode. The user input unit 707 includes at least one of a touch panel 7071 and another input device 7072. The touch panel 7071 is also referred to as a touchscreen. The touch panel 7071 may include two parts: a touch detection apparatus and a touch controller. The another input device 7072 may include, but is not limited to, a physical keyboard, a function key (such as a volume control key or a switch key), a trackball, a mouse, and a joystick. Details are not described herein again.

In this embodiment of this application, after receiving downlink data from the network-side device, the radio frequency unit 701 may transmit the downlink data to the processor 710 for processing. In addition, the radio frequency unit 701 may transmit uplink data to the network-side device. Generally, the radio frequency unit 701 includes, but is not limited to, an antenna, an amplifier, a transceiver, a coupler, a low noise amplifier, a duplexer, and the like.

The memory 709 may be configured to store a software program or instructions and various data. The memory 709 may mainly include a first storage area for storing a program or instructions and a second storage area for storing data. The first storage area may store an operating system, an application program or instructions required by at least one function (for example, a sound playback function and an image display function), and the like. In addition, the memory 709 may include a volatile memory or a non-volatile memory, or the memory 709 may include both a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch Link DRAM (SLDRAM), and a Direct Rambus RAM (DRRAM), and the like. The memory 709 in this embodiment of this application includes, but is not limited to, these memories and any other suitable type of memory.

The processor 710 may include one or more processing units. In some embodiments, the processor 710 integrates an application processor and a modem processor. The application processor mainly processes operations related to an operating system, a user interface, an application program, and the like. The modem processor mainly processes wireless communication signals, for example, a baseband processor. It may be understood that, in some embodiments, the foregoing modem processor may not be integrated into the processor 710.

The processor 710 is configured to perform SL transmission in a mini-slot, where

a length of the mini-slot is less than a length of one slot, and one slot includes one or more starting positions of the mini-slot.

In some embodiments, the mini-slot meets one or more of the following:

one AGC symbol exists at a starting position of the mini-slot;

one GAP symbol exists at an end position of the mini-slot;

one AGC symbol exists at a starting position of the SL transmission of a 1st mini-slot in one slot;

one GAP symbol exists at an end position of SL transmission of a last mini-slot in one slot;

M AGC symbols are configured in one slot, and the SL transmission of each mini-slot starts after each AGC symbol, where M is a number of the mini-slots in one slot; and

one first symbol is configured between two adjacent mini-slots in one slot, where the first symbol is the GAP symbol or the AGC symbol.

In some embodiments, the processor 710 is configured to perform one or more of the following:

in a case that an AGC symbol of the mini-slot conflicts with a demodulation reference signal (DMRS) symbol, transmitting the AGC symbol after the DMRS symbol;

in a case that an AGC symbol of the mini-slot conflicts with a DMRS symbol, shifting the DMRS symbol backward by one symbol; and

in a case that an AGC symbol of the mini-slot conflicts with a DMRS symbol, selecting a DMRS pattern that does not conflict with the AGC symbol.

In some embodiments, the starting position of the mini-slot meets one or more of the following:

the starting position of the mini-slot is located after X symbols from a previous physical sidelink control channel PSCCH transmission occasion, where X is time for demodulating a PSCCH; and

Y GAP symbols exist before the starting position of the mini-slot, and deferred listen before talk deferred LBT is performed in the GAP symbols.

In some embodiments, in a case that a transmission resource of a PSFCH overlaps with a transmission resource of the mini-slot, the processor 710 is configured to:

transmit the PSFCH;

end the SL transmission in the mini-slot in advance, or postpone the start of the SL transmission in the mini-slot; and

transmit the PSFCH in a part of symbols in the mini-slot, and transmit data in another part of symbols in the mini-slot.

In some embodiments, the processor 710 is further configured to:

determine a starting position of the PSFCH as an end position of the mini-slot; and

determine an end position of the PSFCH as the starting position of the mini-slot.

An embodiment of this application further provides a readable storage medium. The readable storage medium stores a program or instructions. When the program or the instructions are executed by a processor, the processes of the foregoing transmission method embodiments are implemented, and the same technical effects can be achieved. To avoid repetition, details are not described herein again.

The processor is a processor in the terminal in the foregoing embodiments. The readable storage medium includes a computer-readable storage medium, for example, a computer read-only memory ROM, a random access memory RAM, a magnetic disk, or an optical disc.

An embodiment of this application further provides a chip, including a processor and a communication interface. The communication interface is coupled to the processor, and the processor is configured to run a program or instructions, to implement all processes of the foregoing transmission method embodiments, and the same technical effects can be achieved. To avoid repetition, details are not described herein again.

It should be understood that, the chip described in the embodiments of this application may also be referred to as a system-level chip, a system chip, a chip system, a system on chip, or the like.

An embodiment of this application further provides a computer program/program product. The computer program/program product is stored in a storage medium and executed by at least one processor to implement all processes of the foregoing transmission method embodiments, and the same technical effects can be achieved. To avoid repetition, details are not described herein again.

It should be noted that, in this text, the terms “include”, “comprise”, and any variants thereof are intended to cover a non-exclusive inclusion. Therefore, in the context of a process, method, object, or device that includes a series of elements, the process, method, object, or device not only includes such elements, but also includes other elements not specified expressly, or may include inherent elements of the process, method, object, or device. Unless otherwise specified, an element limited by “include a/an . . . ” does not exclude other same elements existing in the process, the method, the article, or the device that includes the element. In addition, it should be noted that the scope of the methods and apparatuses in the embodiments of this application is not limited to performing the functions in the order shown or discussed, but also can include performing the functions in basically the same way or in the opposite order according to the functions involved, for example, the described methods may be performed in a different order from the described ones, and various steps can also be added, omitted, or combined. In addition, features described with reference to some examples may be combined in other examples.

Through the foregoing description on the implementations, a person skilled in the art can clearly learn that the foregoing embodiment methods may be implemented by using software in combination with a necessary universal hardware platform. Certainly, the embodiment methods may also be implemented by using hardware, but the former is a better implementation in many cases. Based on such an understanding, the technical solutions in this application essentially or the part contributing to the conventional technologies may be implemented in the form of a computer software product. The computer software product is stored in a storage medium (for example, a ROM/RAM, a magnetic disk, or an optical disc), and includes several instructions for instructing a terminal (which may be a mobile phone, a computer, a server, an air conditioner, a network device, or the like) to perform the method described in the embodiments of this application.

The embodiments of this application are described above with reference to the accompanying drawings, but this application is not limited to the foregoing detailed description. The foregoing detailed description is merely illustrative rather than limited. Under the inspiration of this application, a person skilled in the art may make many forms without departing from the purpose of this application and the protection of the claims, all of which fall within the protection of this application.

What is claimed is:

1. A transmission method, comprising:
performing, by a terminal, a sidelink (SL) transmission in a mini-slot, wherein
a length of the mini-slot is less than a length of one slot, and one slot comprises one or more starting positions of the mini-slot.

2. The method according to claim 1, wherein the mini-slot meets one or more of the following:
one automatic gain control (AGC) symbol exists at a starting position of the mini-slot;
one gap symbol exists at an end position of the mini-slot;
one AGC symbol exists at a starting position of the SL transmission of a first mini-slot in one slot;
one gap symbol exists at an end position of SL transmission of a last mini-slot in one slot;
M AGC symbols are configured in one slot, and the SL transmission of each mini-slot starts after each AGC symbol, wherein M is a number of the mini-slots in one slot; or
one first symbol is configured between two adjacent mini-slots in one slot, wherein the first symbol is the gap symbol or the AGC symbol.

3. The method according to claim 1, further comprising one or more of the following:
when an AGC symbol of the mini-slot conflicts with a demodulation reference signal (DMRS) symbol, transmitting, by the terminal, the AGC symbol after the DMRS symbol;
when an AGC symbol of the mini-slot conflicts with a DMRS symbol, shifting, by the terminal, the DMRS symbol backward by one symbol; or
when an AGC symbol of the mini-slot conflicts with a DMRS symbol, selecting, by the terminal, a DMRS pattern that does not conflict with the AGC symbol.

4. The method according to claim 1, wherein the starting position of the mini-slot meets one or more of the following:
the starting position of the mini-slot is located after X symbols from a previous physical sidelink control channel (PSCCH) transmission occasion, wherein X is time for demodulating a PSCCH; or
Y gap symbols exist before the starting position of the mini-slot, and the terminal performs deferred listen before talk (LBT) in the gap symbols.

5. The method according to claim 1, wherein when a transmission resource of a physical sidelink feedback channel (PSFCH) overlaps with a transmission resource of the mini-slot, the method further comprises one or more of the following:
transmitting, by the terminal, the PSFCH;
ending, by the terminal, the SL transmission in the mini-slot in advance, or postponing, by the terminal, the start of the SL transmission in the mini-slot; or
transmitting, by the terminal, the PSFCH in a part of symbols in the mini-slot, and transmitting data in another part of symbols in the mini-slot.

6. The method according to claim 5, wherein
the ending, by the terminal, the SL transmission in the mini-slot in advance comprises:
determining, by the terminal, a starting position of the PSFCH as an end position of the mini-slot, and
the postponing, by the terminal, the start of the SL transmission in the mini-slot comprises:
determining, by the terminal, an end position of the PSFCH as the starting position of the mini-slot.

7. A terminal, comprising a processor and a memory storing instructions, wherein the instructions, when executed by the processor, cause the processor to perform operations comprising:
performing a sidelink (SL) transmission in a mini-slot, wherein
a length of the mini-slot is less than a length of one slot, and one slot comprises one or more starting positions of the mini-slot.

8. The terminal according to claim 7, wherein the mini-slot meets one or more of the following:
one automatic gain control (AGC) symbol exists at a starting position of the mini-slot;
one gap symbol exists at an end position of the mini-slot;
one AGC symbol exists at a starting position of the SL transmission of a first mini-slot in one slot;
one gap symbol exists at an end position of SL transmission of a last mini-slot in one slot;
M AGC symbols are configured in one slot, and the SL transmission of each mini-slot starts after each AGC symbol, wherein M is a number of the mini-slots in one slot; or
one first symbol is configured between two adjacent mini-slots in one slot, wherein the first symbol is the gap symbol or the AGC symbol.

9. The terminal according to claim 7, wherein the instructions, when executed by the processor, cause the processor to further perform operations comprising one or more of the following:
when an AGC symbol of the mini-slot conflicts with a demodulation reference signal (DMRS) symbol, transmitting the AGC symbol after the DMRS symbol;
when an AGC symbol of the mini-slot conflicts with a DMRS symbol, shifting the DMRS symbol backward by one symbol; or
when an AGC symbol of the mini-slot conflicts with a DMRS symbol, selecting a DMRS pattern that does not conflict with the AGC symbol.

10. The terminal according to claim 7, wherein the starting position of the mini-slot meets one or more of the following:
the starting position of the mini-slot is located after X symbols from a previous physical sidelink control channel (PSCCH) transmission occasion, wherein X is time for demodulating a PSCCH; or
Y gap symbols exist before the starting position of the mini-slot, and the terminal performs deferred listen before talk (LBT) in the gap symbols.

11. The terminal according to claim 7, wherein when a transmission resource of a physical sidelink feedback channel (PSFCH) overlaps with a transmission resource of the mini-slot, the instructions, when executed by the processor, cause the processor to further perform operations comprising one or more of the following:
transmitting the PSFCH;
ending the SL transmission in the mini-slot in advance, or postponing the start of the SL transmission in the mini-slot; or
transmitting the PSFCH in a part of symbols in the mini-slot, and transmitting data in another part of symbols in the mini-slot.

12. The terminal according to claim 11, wherein
the ending the SL transmission in the mini-slot in advance comprises:
determining a starting position of the PSFCH as an end position of the mini-slot, and
the postponing the start of the SL transmission in the mini-slot comprises:
determining an end position of the PSFCH as the starting position of the mini-slot.

13. A non-transitory computer-readable storage medium storing instructions, wherein the instructions, when executed by a processor, cause the processor to perform operations comprising:
performing a sidelink (SL) transmission in a mini-slot, wherein
a length of the mini-slot is less than a length of one slot, and one slot comprises one or more starting positions of the mini-slot.

14. The non-transitory computer-readable storage medium according to claim 13, wherein the mini-slot meets one or more of the following:
one automatic gain control (AGC) symbol exists at a starting position of the mini-slot;
one gap symbol exists at an end position of the mini-slot;
one AGC symbol exists at a starting position of the SL transmission of a first mini-slot in one slot;
one gap symbol exists at an end position of SL transmission of a last mini-slot in one slot;
M AGC symbols are configured in one slot, and the SL transmission of each mini-slot starts after each AGC symbol, wherein M is a number of the mini-slots in one slot; or
one first symbol is configured between two adjacent mini-slots in one slot, wherein the first symbol is the gap symbol or the AGC symbol.

15. The non-transitory computer-readable storage medium according to claim 13, wherein the instructions, when executed by the processor, cause the processor to further perform operations comprising one or more of the following:
when an AGC symbol of the mini-slot conflicts with a demodulation reference signal (DMRS) symbol, transmitting the AGC symbol after the DMRS symbol;
when an AGC symbol of the mini-slot conflicts with a DMRS symbol, shifting the DMRS symbol backward by one symbol; or
when an AGC symbol of the mini-slot conflicts with a DMRS symbol, selecting a DMRS pattern that does not conflict with the AGC symbol.

16. The non-transitory computer-readable storage medium according to claim 13, wherein the starting position of the mini-slot meets one or more of the following:
the starting position of the mini-slot is located after X symbols from a previous physical sidelink control channel (PSCCH) transmission occasion, wherein X is time for demodulating a PSCCH; or
Y gap symbols exist before the starting position of the mini-slot, and the terminal performs deferred listen before talk (LBT) in the gap symbols.

17. The non-transitory computer-readable storage medium according to claim 13, wherein when a transmission resource of a physical sidelink feedback channel (PSFCH) overlaps with a transmission resource of the mini-slot, the instructions, when executed by the processor, cause the processor to further perform operations comprising one or more of the following:
transmitting the PSFCH;
ending the SL transmission in the mini-slot in advance, or postponing the start of the SL transmission in the mini-slot; or
transmitting the PSFCH in a part of symbols in the mini-slot, and transmitting data in another part of symbols in the mini-slot.

18. The non-transitory computer-readable storage medium according to claim 17, wherein
the ending the SL transmission in the mini-slot in advance comprises:
determining a starting position of the PSFCH as an end position of the mini-slot, and
the postponing the start of the SL transmission in the mini-slot comprises:
determining an end position of the PSFCH as the starting position of the mini-slot.
